(19) United States
(12) Patent Application Publication
(10) Pub. No.: US 2005/0183260 A1
(43) Pub. Date: Aug. 25, 2005

(54) Device for assembly of several elements by riveting and procedure for assembly of panels especially for aircraft fuselages by means of said device

(76) Inventor: Cedric Meyer, Fonsorbes (FR)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/010,187

(22) Filed: Dec. 10, 2004

(30) Foreign Application Priority Data
Dec. 10, 2003 (FR) 03 14482

(51) Int. Cl. B64C 35/00; B21D 39/00

(52) U.S. Cl. 29/524.1; 29/525.06; 29/812.5; 29/715

(57) ABSTRACT

The subject of the invention is a device for assembly of several elements by riveting, the device including rivets or analogs, the shank of which has an elliptical or analogous cross-section placed and riveted in holes with an elliptical or analogous cross-section corresponding to that of the shank, laid out in the elements to be assembled. The invention also includes a method for assembling panels to make a fuselage of an aircraft.

### RELATED APPLICATION

The present application claims priority to French Application No. 03 14482 filed Dec. 10, 2003.

### FIELD OF THE INVENTION

The present invention concerns, generally speaking, the assembly of several elements by riveting and, more specifically, the assembly of panels with relatively large dimensions consisting of very thin sheet metal, before making the aircraft fuselage.

### BACKGROUND OF THE INVENTION

The fuselage of an aircraft consists of tubular sections abutting each other, which follow joining lines, commonly called orbital seams, defining planes perpendicular to the longitudinal axis of the fuselage, the said sections themselves generally each consisting of several panels joined together along joining lines, called longitudinal seams, corresponding to one of the generatrices of said section.

These seams, both orbital and longitudinal, are zones of fragility for the fuselage, which should be reinforced in order to resist the high stresses to which the fuselage is subject in-flight, resulting from the combined actions of weight, aerodynamic forces, propulsive forces, as well as the pressurization of the aircraft's cabin.

For this reason, the longitudinal seams of the fuselage are generally made by overlapping the edges of the two panels to be assembled; the joining normally being accomplished by means of at least two rows of mounting rivets in the zone where the two panels overlap.

The orbital seams are generally made using a ferrule placed on the inner wall of the fuselage with at least two parallel rows of mounting rivets joining the edge of each section with said ferrule.

Generally, a circumferential stiffener with a T-shaped cross section, more commonly called the frame, is placed on the face of the said ferrule opposite the face in contact with the edges of the sections. This frame is joined with the ferrule and each section by means of one of the two aforementioned parallel rows of rivets.

The purpose of the invention is to perfect these assembly methods by improving their performance, in particular the resistance to fatigue and also the manufacturing cost.

### SUMMARY OF THE INVENTION

To that end, the subject of the invention, generally speaking, is a device for the assembly of several elements by riveting characterized by the fact that it consists of rivets or analogs, the shank of which has an elliptical or analogous section, placed and riveted in holes with an elliptical or analogous section corresponding to that of the shank, laid out in the elements to be assembled.

Such an assembly device has the advantage—due to better channeling of the flow of stress propagating in the plane of the assembled elements parallel to the major axis of the elliptical holes—of noticeably reducing the localized overstress on the two opposite sides adjoining the major axis of said elliptical holes.

Thus, the fatigue resistance of the assembly is improved by avoiding the appearance of cracks likely to lead to damaging ruptures by reducing the stress on the inner sides of the holes.

Optimal stress reduction is obtained by sizing the major and minor axes of the elliptical or analogous cross-section of the rivets and holes in a ratio of order two, leading to a reduction of the concentration coefficient of stress of order 33%, and having the advantage of allowing the elimination of a row of mounting rivets when three had been called for in conventional assemblies.

The invention also seeks to apply such an assembly device to making an aircraft fuselage and, to that end, has as a subject a procedure for assembling sheet metal panels of relatively large dimensions and small thicknesses to make up the fuselage of an aircraft; the fuselage including annular sections butted together along the orbital seams, the sections each consisting of one or several panels butted together along the longitudinal seams; the procedure being characterized by the fact that, on the one hand, on each section one or more longitudinal seams are made by overlapping the edges of two panels to be assembled with the joining of the overlapping parts being done by drilling holes with elliptical or analogous cross sections in the parts with the major axis orthogonal to the longitudinal seam, and then riveting the parts with the rivets or analogs with the shank having an elliptical or analogous cross section corresponding to that of the holes and, on the other hand, each orbital seam joining two of the sections side-by-side is made by means of a ferrule applied on the inner wall of the fuselage adjoining the overlapped parts of the sections; the ferrule and adjoining sections being assembled by riveting; the riveting being done, in at least two opposite zones astride the orbital seams on the upper and lower generatrices of the fuselage, by drilling holes with elliptical or analogous cross-section with the major axis parallel to the generatrices and placing rivets or analogs with the shank having an elliptical or analogous cross section corresponding to that of the holes.

The fact that mounting holes are made along the longitudinal seams of the fuselage sections, using elliptical cross sections, the major axis of which is orthogonal to the seams, makes it possible to better distribute the pulling stress generated, in particular, by cabin pressurization, while reducing the concentration of stress on the opposite sides of the holes on both sides of the major axis, the surfaces of which are thereby enlarged by stretching of the holes resulting from giving them an oval shape.

As for the orbital seams, the zones subject to the most stress are those near the upper and lower generatrices of the fuselage, where the pulling and compressive stresses are maximal.

The fact that mounting holes with an elliptical cross section, the major axis of which is parallel to the generatrices, are made in these two zones of the orbital seams the major axis of which makes it possible to reduce, in the same manner as for the longitudinal seams, the concentration of stress on the sides of the most stressed holes.

In an advantageous embodiment, the ratio between the major and minor axes of the cross-section of the mounting holes and corresponding rivets is of order two; this leads to an optimal compromise between a purely circular cross-section and an excessively oval shape, and allows reducing the coefficient of stress concentration Kₜ on the order of 33%.

The extent of the zones on the orbital seams where elliptical rivets are placed, on both sides of the upper and lower generatrices, is variable. They need not extend very far in the direction of the generatrices halfway between the upper and lower generatrices, which correspond to the neutral axes of the theoretical beam made up by the fuselage. The pulling or compressive stresses generated parallel to the axis of the fuselage will effectively decrease from the upper and lower generatrices until becoming null to the right of the “neutral” generatrices where the mounting holes can be circular, just like in the adjacent zones as well.

Further, all types of rivets can be used in accordance with the invention, to the extent that they can be made with an elliptical shank. Preferably rivets of a known splittable type are used, having an elliptical shank extended by a circular part with a reduced diameter, with steps or threads and splittable, allowing the placement of an anchoring and retaining ring for the rivet, in the well-known manner.

### BRIEF DESCRIPTION OF THE DRAWINGS

Other properties and advantages will be seen in the description below of a method of making use of the process from the invention; this description is given solely as an example and in light of the attached drawings where:

FIGS. 1a, 1b, and 1c are respectively a view of the end, head side, of an elliptical rivet according to the invention; a lateral view of the rivet in the plane of the major axis; and a lateral view in the plane of the minor axis.

FIG. 2 is an axial cross-section of an assembly of two sheets, for example metallic, by means of the rivet from FIGS. 1a to 1c.

FIG. 3 is a cross-section view along nine III-III of the assembly from FIG. 2.

FIG. 4 is a diagram showing the change of the ratio K between the value of the coefficient of stress concentration Kₜ for an elliptical hole and the value of the same coefficient but for a circular hole, as a function of the change of the cross-section of the rivets mounting hole.

FIG. 5 is a schematic view in perspective of the two aircraft fuselage sections to be assembled.

FIG. 6 is a partial enlarged view of an extremity of a section.

FIG. 7 is a partial cross-section of a section in the area of a longitudinal seam.

FIG. 8 is a view from the left of the assembly from FIG. 7.

FIG. 9 is a partial cross-section view in the area of a conventional orbital seam at the junction of two sections.

FIG. 10 is a partial view of the assembly of two sections according to the invention, in the area of the orbital seam corresponding to the fuselage's upper generatrix.

### DETAILED DESCRIPTION OF THE INVENTION

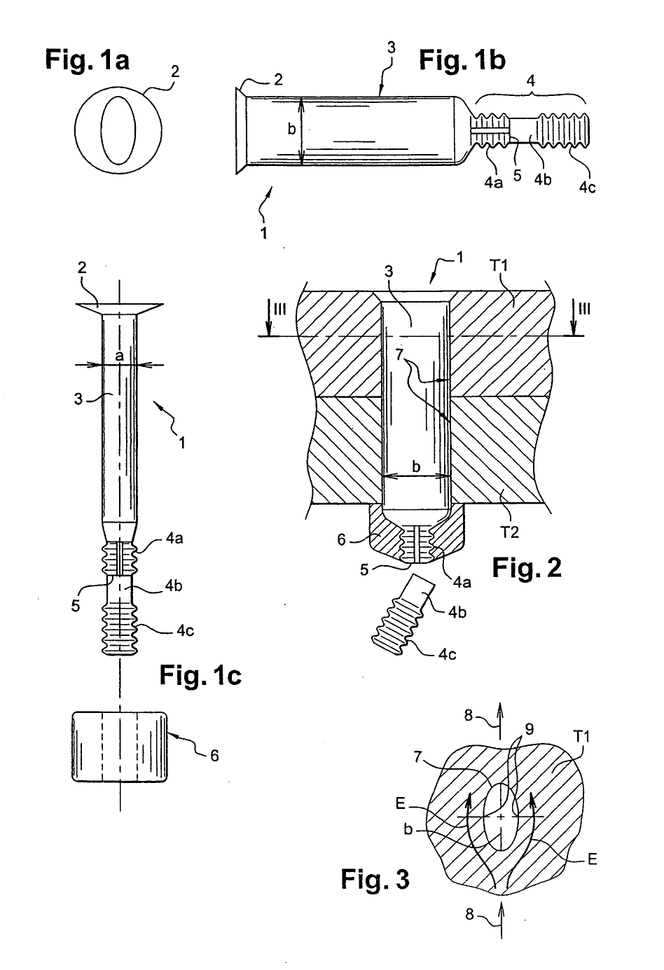

In FIGS. 1a, 1b and 1c a rivet 1 according to the invention is shown.

This rivet 1 is of a well-known type, including a countersunk head 2 and a shank 3, extended axially by a cylindrical part 4, itself including a step zone 4a adjoining shank 3, an intermediate smooth zone 4b separated from the zone 4a by a break notch 5 of part 4, and, finally, a terminal step zone 4c.

The part 4 is the known art method of setting the rivet and performing the riveting by means of an annular ring 6.

The rivet 1 according to the invention is characterized by a shank 3 with an elliptical or analogous cross-section, for example a cross-section with a minor axis a (FIG. 1c) equal to half the major axis b (FIG. 1b).

FIG. 2 shows rivet 1 joining two pieces of sheet metal T1 and T2, in which are set holes 7 with the same cross-section as the shank 3 or a similar section, if mounting the rivets with interference, specifically positive, is desired.

The rivet 1 is set by crimping the ring 6 on the end 4a which remains in place, the parts 4b and 4c being separated by breaking right at the notch 5; the method of setting such a rivet in place is well known.

FIG. 3 represents a cross-section of the sheet metal T1 in the plane perpendicular to the rivet 1 and following the line III-III from FIG. 2.

Assuming that the pulling stresses are applied to the sheet T1 along the direction of the arrows 8, meaning parallel to the major axis b of hole 7, the fact of stretching the hole 7 in this direction by making its shape oval assures a better distribution of stresses on the opposite sides 9 on both sides of the major axis b of the hole 7. The stresses generated by the flux of stress symbolized by the arrows E are effectively distributed on a much larger surface than it would be were hole 7 purely circular.

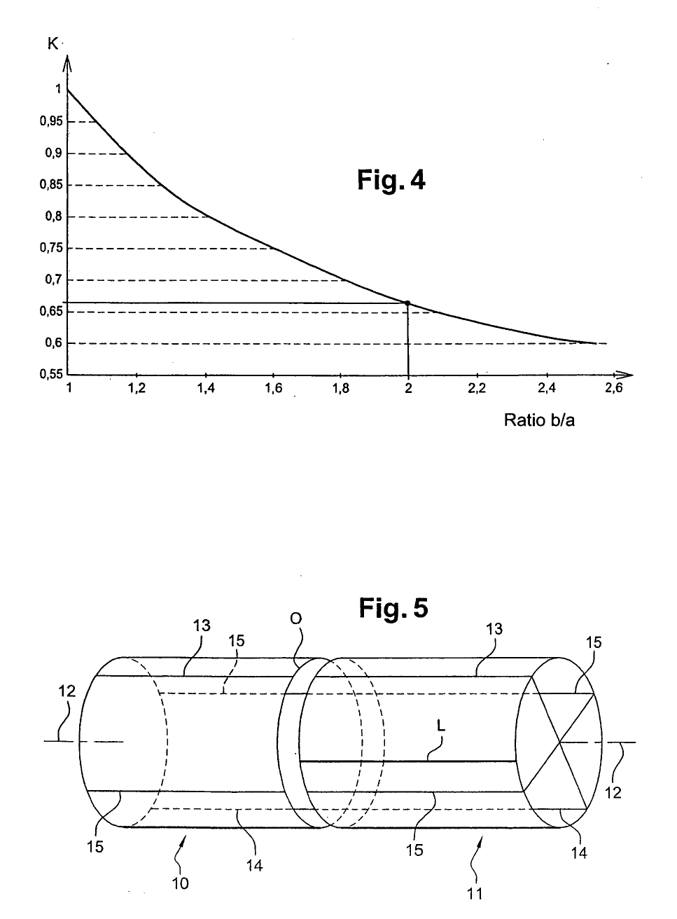

FIG. 4 is a diagram showing the change of the ratio K between the value of the concentration coefficient Kₜ (to the right of the sides of the rivet's holes) 1 for an elliptical hole and the value of the same coefficient but for a circular hole, as a function of the deformation of the cross-section of the holes, starting from a hole with a purely circular cross-section (K=1).

In FIG. 4, the abscissa shows the ratio b/a, which goes from 1 to 2.6, whereas on the ordinate the values of K going from 0.55 up to 1 for the circular hole are shown.

The major axis to minor axis ratio (b/a) of 2 appears to be optimal and leads to a reduction of the coefficient K on the order of 33% (K=0.67). It is of course possible to deviate from this value, up or down, depending on the nature of the joint to be made.

The rivet 1 of this invention is particularly appropriate for assembly of aircraft fuselage sections, along with the elements making up each section.

In FIG. 5, two fuselage sections are shown schematically, respectively 10 and 11; they are to be joined along a seam line referred to as orbital shown at O consisting of a circle or an analog, according to the fuselage cross-section, the plane of which is perpendicular to the longitudinal axis 12 of the fuselage.

At 13 in FIG. 5 the upper generatrix of the fuselage is shown, at 14 the lower generatrix is shown and at 15 the two generatrices located in the neutral plane of the theoretical beam made up by the fuselage.

Finally at L a seam, referred to as longitudinal, for assembly of two elements of the section 11 is shown; this seam is parallel to the axis 12 of the fuselage, or more precisely coincident with a generatrix of said section 11.

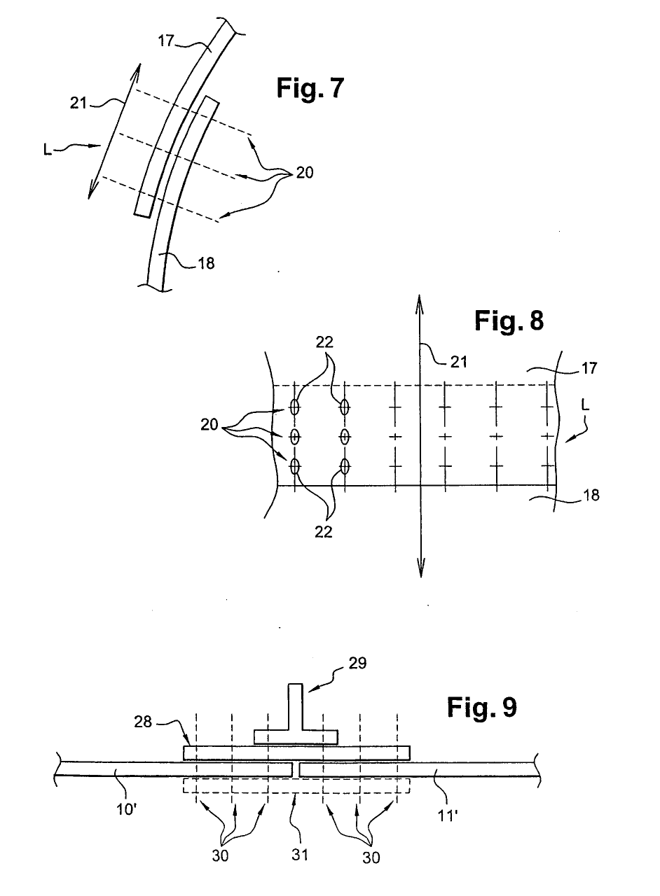

In FIGS. 7 and 8 the construction of a longitudinal seam, such as the seam L, according to the invention is shown, specifically by using the assembly device from FIGS. 1a, 1b, 1c, 2 and 3 for the riveting.

FIG. 7 shows in transverse cross-section of the seam L, and the panels to be butted together for the section under consideration (11), generally consisting of panels or sheets, for example metallic, shown at 17 and 18. The assembly is performed by overlapping the adjoining edges of panels 17 and 18, three series of rivets 20 joining the overlapping edges of said panels.

At 21 in FIGS. 7 and 8 the direction of the pulling stresses subsequently exerted on the section by pressurization of the aircraft cabin are shown; these stresses act perpendicularly to the seam L.

In accordance with the invention, the holes 22 anchoring the joint are made in the panels 17 and 18 with an elliptical or analogous cross-section of the major axis of which is orthogonal to the seam L, which means it is parallel to the direction of the stresses 21.

Elliptical or analogous cross-section means a purely elliptical cross-section or an oval cross-section of any kind defining mutually perpendicular major and minor axes.

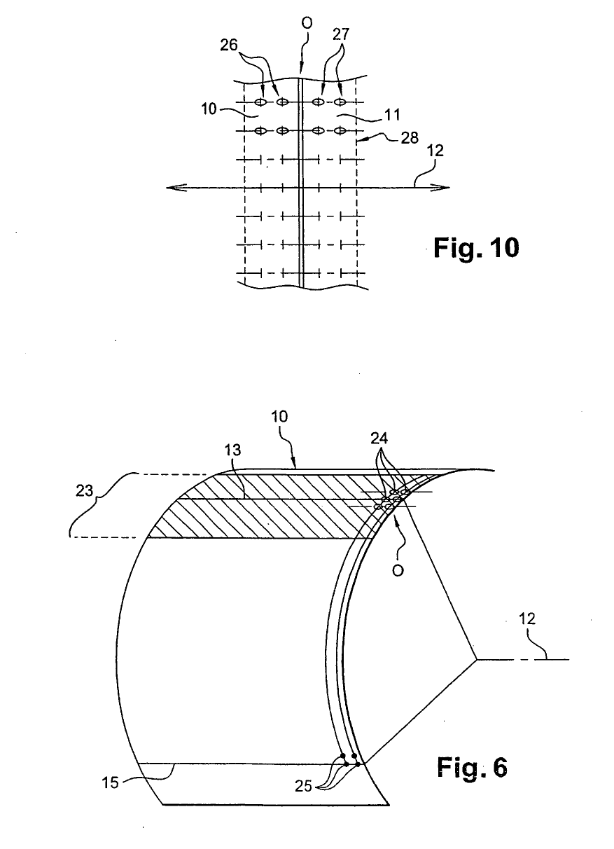

FIG. 6 shows the application of the invention to the construction of an orbital seam like the seam O in FIG. 5.

In this type of seam, the stresses exerted, in particular pulling and compression, are concentrated in the areas of the fuselage straddling the upper 13 and lower 14 generatrices and parallel to these generatrices.

FIG. 6 shows a band astride the upper generatrix 13, corresponding to the area of section 10 area with the highest stress, and in which the anchoring holes 24 for the butted sections have, in accordance with the invention, an elliptical or analogous cross-section with a major axis parallel to the generatrix 13. The same applies symmetrically to the zone of the lower generatrix 14, analogous to the zone of band 23.

The width of the band 23 is more or less significant. It is not necessary for all the anchoring holes and rivets of the orbital seam O to have an elliptical cross-section because the greater the distance from the generatrix 13 towards the neutral generatrix 15, the less significant the pulling and compressing stresses; these latter even become theoretically null near the generatrix 15. Therefore outside the zones 23, the holes and associated rivets can have a conventional circular cross-section like the holes 25 shown in FIG. 6.

FIG. 10 shows at O an orbital seam line for the junction of two sections 10 and 11 from FIG. 5, the seam being constructed with the help, on each section, of two rows, 26 and 27, of means of assembly according to the invention, specifically holes and rivets with elliptical cross-sections the major axis of which is orthogonal to the seam O, meaning parallel to the longitudinal axis 12 of the fuselage. At 28 a ferrule mounted astride the seam O is shown.

In comparison, FIG. 9 shows a cross-section of a conventional orbital seam made with holes and rivets having a circular cross-section.

At 10′ and 11′ sections to be abutted are shown. The assembly is done by means of a ferrule 28 applied on the inner wall of the fuselage astride the seam. Further, generally a frame with a T-shaped cross-section, shown at 29, is placed on the face of the ferrule 28 opposite the face in contact with the edges of the section 10′, and 11′.

This mode of assembly generally demands providing for the end of each section three rows 30 of conventional rivets, one of which also joins the frame 29 with the ferrule 28.

An external ferrule, such as that shown in dashes at 31, can be necessary in certain zones subject to very high mechanical stresses (or loads) in order to reinforce it.

By replacing this mode of assembly, the invention makes it possible, with equal performance in terms of resistance to fatigue, either to reduce the number of rows of rivets from 3 to 2 as shown by FIG. 10, or to eliminate the external ferrule 31.

In so doing, weight is improved, assembly is simplified, and the costs, not only of manufacturing, but also of commercial operation of the aircraft, are reduced.

It should finally be noted that other types of rivets or analogs than those shown and described above can be used to the extent that they include a shank that can be conformed with an elliptical or analogous cross-section.

The elliptical holes (22, 24 and 26) can be made without difficulty by orbital drilling, whereas the elliptical shanks for the rivets or analogs can also be made without technical difficulty by machining, die-forging or molding.

If installing rivets with interference, in particular positive, is desired, holes (22, 24 and 26) with cross-section corresponding to that of the rivets' (3) shanks will be drilled to obtain the interference sought.

Of course, the described assembly device is shown in FIG. 2 and can be used for other assemblies than sections or elements of sections of aircraft fuselage, to the extent where the elements to be assembled are subject to stresses, in particular of pulling or compression, exerted in a particular direction perpendicular to the axis of the mounting holes, the direction of which should be that of the orientation of the major axis of the cross-section of the holes and associated rivets of said assemblies.

Further, the process envisioned by the invention is applicable to the assembly of panels of all types of sheets and particularly sheet metal, sheets of composite material and FML (Fiber Metal Laminate) type sheets, consisting of a laminated sheet including at once at least one metal layer and at least one layer of fiberglass.

1. A device for the assembly of a plurality of elements by riveting, comprising rivets or analogs, a shank of the rivet or analog having an elliptical or analogous cross-section placed and riveted in a hole having an elliptical or analogous cross-section corresponding to the cross-section of the shank, laid out in the elements to be assembled.

2. A device according to claim 1, wherein a ratio between a major axis and a minor axis of the elliptical or analogous cross-section of the rivets and the holes is on the order of about 2.

3. A method for assembling panels of relatively large dimensions and small thicknesses to form a fuselage of an aircraft, the fuselage including annular sections butted together along orbital seams, the sections each comprising one or more panels abutting along longitudinal seams, the method comprising the steps of:
forming an overlapping portion on each section of one or more longitudinal seams by overlapping edges of adjacent panels to be assembled;
assembling the overlapping portion by drilling holes with elliptical or analogous cross-sections in the overlapping portions with the major axis orthogonal to the longitudinal seam;
riveting the portion with rivets or analogs having a shank with an elliptical or analogous cross-section corresponding to the cross-section of the holes;
forming each orbital seam joining two of the sections side-by-side by applying a ferrule on an inner wall of the fuselage adjoining the overlapping portions of the sections;
assembling the ferrule and adjoining sections by riveting, the said riveting, in at least two opposite zones astride the orbital seams on upper and lower generatrices of the fuselage, wherein the riveting comprises drilling holes having elliptical or analogous cross-sections with a major axis parallel to the generatrices; and
placing the rivets or analogs having shanks with elliptical or analogous cross-sections corresponding to the cross-sections of the holes.

4. The method according to claim 3, wherein the holes and the shanks of the rivets or analogs have elliptical or analogous cross-sections, a ratio between a major and a minor axis of which is on the order of about 2.

5. The method according to claim 3, wherein the holes are drilled with a cross-section corresponding to a cross-section of the shanks of the rivets to mount the rivets with interference.

6. The method according to claim 3, wherein the panels are formed from one of the group consisting of sheet metal, sheets in composite material, and laminated sheet including at least one metal layer and at least one of fiberglass layer.
